(19) United States
(12) Patent Application Publication
(10) Pub. No.: US 2019/0293220 A1
(43) Pub. Date: Sep. 26, 2019

(54) LIGHT-EMITTING HOSE ASSEMBLY

(71) Applicant: AGREAT SHOWER & SANITARY (XIAMEN) CO., LTD., Xiamen City (CN)

(72) Inventor: Pi Kuang Tsai, Xiamen City (CN)

(21) Appl. No.: 16/362,693

(22) Filed: Mar. 25, 2019

(30) Foreign Application Priority Data
Mar. 26, 2018 (TW) 107203914

(51) Int. Cl. F16L 55/00; F16L 15/00; G01K 1/02; E03C 1/04

(52) U.S. Cl. CPC F16L 55/00; F16L 15/008; E03C 2001/0418; E03C 1/0408; G01K 1/02

(57) ABSTRACT

A light-emitting hose assembly includes: a hose having a water passage extending therethrough. A first connector includes a connector seat, which has an end coupled to an end of the house and an opposite end formed with an internal thread, and a light-emitting device. The connector seat includes water flow channel extending therethrough. The water flow channel is in communication with the water passage of the hose. The light-emitting device is arranged in the water flow channel of the connector seat to receive water to flow therethrough to generate electricity and emit light that transmits out of the connector seat. A second connector is coupled to an opposite end of the hose.

### TECHNICAL FIELD OF THE INVENTION

The present invention relates generally to accessories of a showering device, and more particularly to a light-emitting hose assembly.

### DESCRIPTION OF THE PRIOR ART

A showering device generally comprises a water dispensing device, such as a shower head, a shower pillar or an elevating bar, which is connected to a faucet by a hose to achieve a desired effect of showering.

Showering devices that are currently available in the market may be added with a light emission device that is attached to or combined with a shower head to prompt atmosphere and light illumination. However, the shower head is often replaced constantly and a shower head with lighting effect necessarily increase the cost of maintenance.

### SUMMARY OF THE INVENTION

In view of the above, in order to improve the drawbacks of the prior art that a shower head may be easily to damage and requires a high rate of replacement that leads to an increase of maintenance cost and is thus not suitable for adding an effect of light emission thereto, the present invention provides a light-emitting hose assembly, which comprises: a hose, which is formed with a water passage extending therethrough; a first connector, which comprises a connector seat and a light-emitting device, the connector seat having an end connected to an end of the hose, the connector seat having an opposite end that is formed with an internal thread, the connector seat comprising a water flow channel extending therethrough, the water flow channel being in communication with the water passage of the hose, the light-emitting device being arranged in the water flow channel of the connector seat to receive water to flow therethrough to generate electricity and emit light that transmits out of the connector seat; and a second connector, which is coupled to an opposite end of the hose. As such, since the light-emitting hose assembly generally has a relative lower rate of damage and replacement than that of a shower head, subsequent maintenance expenses that a user must afford can be reduced and illumination can be provided for showering and an indication and alarm of water temperature can be achieved with emission of different colors of light.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view showing a first embodiment of the present invention.

FIG. 2 is another exploded view, taken from a different perspective, showing the embodiment illustrated in FIG. 1.

FIG. 3 is a perspective view of the embodiment illustrated in FIG. 1 in an assembled form.

FIG. 4 is a cross-sectional view of the embodiment of FIG. 1, illustrating a condition of operation.

FIG. 5 is a perspective view showing an application of the embodiment of FIG. 1.

FIG. 6 is a cross-sectional view showing a condition of use of a modified embodiment of the embodiment of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

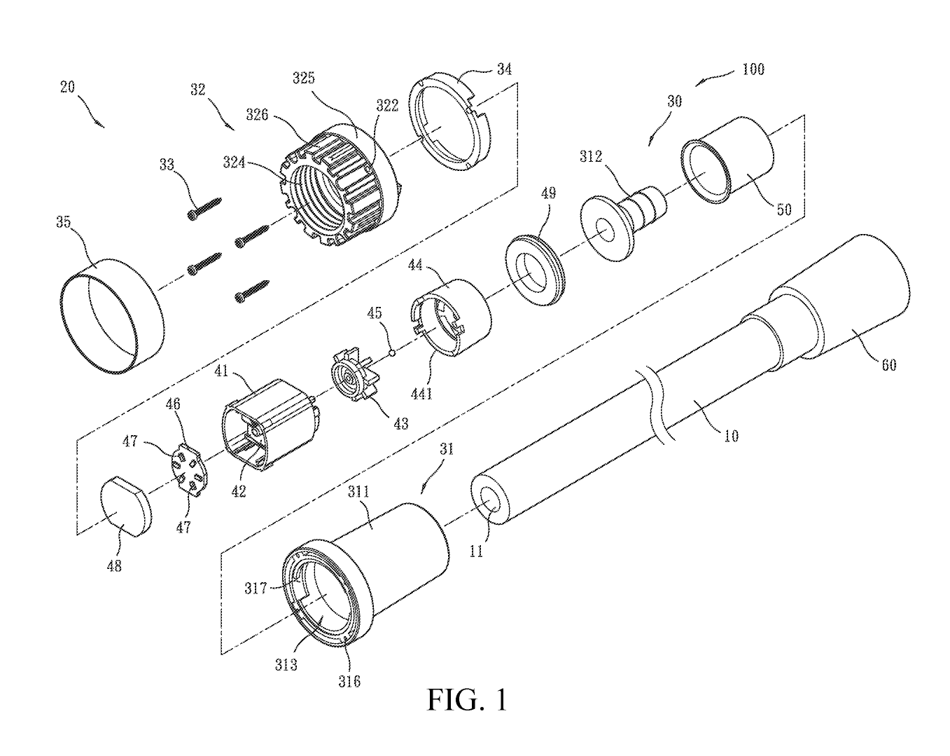

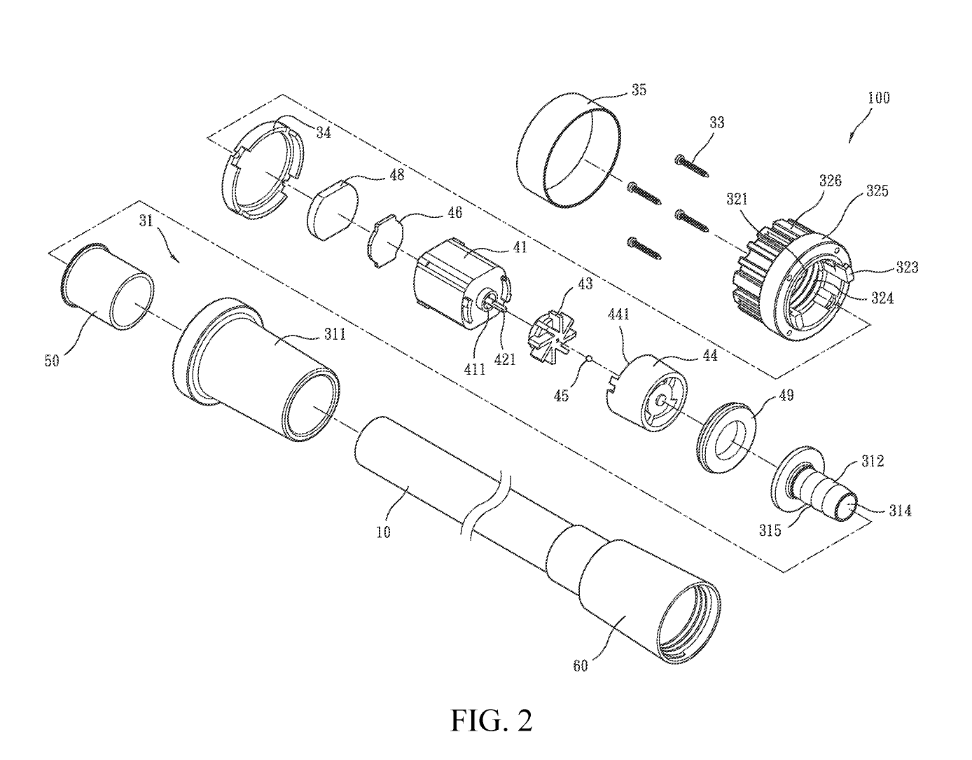

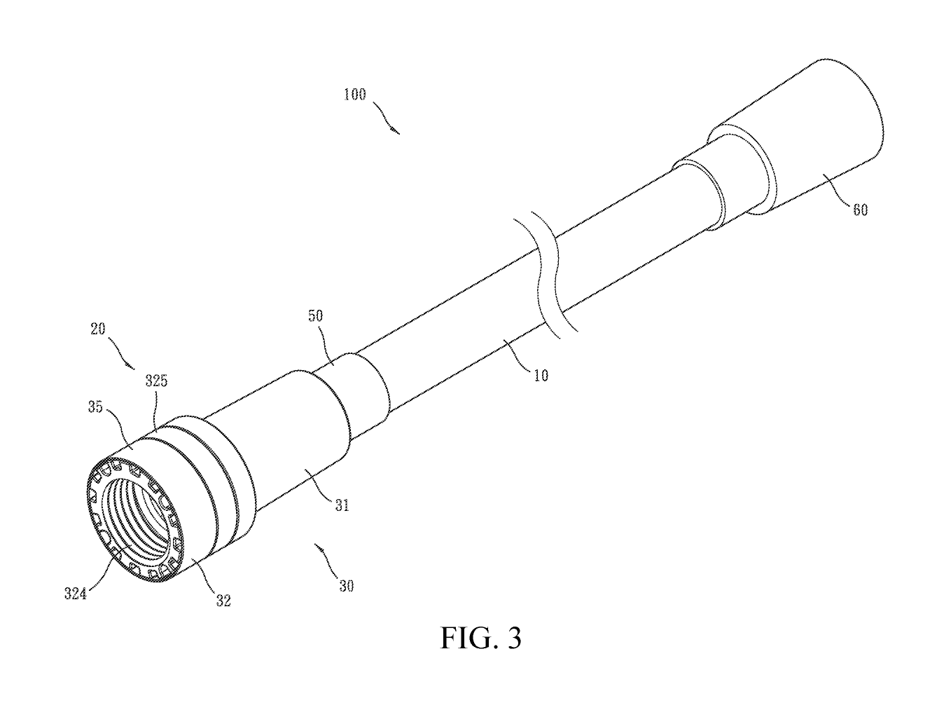

Referring to FIGS. 1-5, a light-emitting hose assembly 100 according to a preferred embodiment generally comprises a hose 10, a first connector 20, and a second connector 60.

Referring to FIGS. 1-4, the hose 10, which is of flexibility, comprises a water passage 11 extending axially therethrough.

Referring to FIGS. 1-4, the first connector 20 is coupled to an end of the hose 10. The first connector 20 comprises a connector seat 30, a light-emitting device 40, and a fastening collar 50.

The connector seat 30 comprises a hose connecting piece 31, an external connecting piece 32, a plurality of pins 33, a gasket 34, and a decoration ring 35. The hose connecting piece 31 comprises a receptacle section 311 and an insert section 312 coupled to an end of the receptacle section 311. The receptacle section 311 has a free end in which a receptacle bore 313 is formed to extend inwardly therefrom. The insert section 312 has a free end in which an insert bore 314 is formed and extends inwardly. The insert bore 314 is arranged in communication with the receptacle bore 313. The insert section 312 has an outer circumferential surface that comprises a plurality of tapering ring sections 315. The insert section 312 is inserted into the water passage 11 at one end of the hose 10 to couple to the hose 10. The free end of the receptacle section 311 has an end face that is formed with a plurality of first positioning holes 316 that are spaced from each other by a predetermined distance. The receptacle bore 313 of the receptacle section 311 has an internal circumferential surface that is formed, through recessing, with a plurality of coupling grooves 317. The external connecting piece 32 comprises a water hole 321 extending axially therethrough. The external connecting piece 32 has an end having an end face that is formed, through recessing, with a plurality of second positioning holes 322 that are spaced from each other by a predetermined distance. The external connecting piece 32 is provided, on a part of an internal circumferential surface of the water hole 321 that is adjacent to the second positioning holes 322, with a plurality of coupling blocks 323 that project outward; and the external connecting piece 32 is provided with an internal thread 324 formed on the internal circumferential surface of the water hole 321 and adjacent to an opposite end thereof. The external connecting piece 32 has an external circumferential surface that is formed with a light transmitting zone 325 that is transparent and a decoration zone 326 that is adjacent to the light transmitting zone 325. The coupling blocks 323 of the external connecting piece 32 is receivable into and combinable with the coupling grooves 317 of the hose connecting piece 31 through rotation in for example a bayonet connection fashion so as to have the hose connecting piece 31 and the external connecting piece 32 coupled to each other. The bolts 33 are received through the second positioning holes 322 of the external connecting piece 32 to screw into the first positioning holes 316 of the hose connecting piece 31, respectively, in order to securely fix the hose connecting piece 31 and the external connecting piece 32 to each other. The gasket 34 is positioned directly against end faces of the hose connecting piece 31 and the external connecting piece 32 that are coupled o each other to prevent leaking of water at the coupling interface therebetween. The decoration ring 35, which is generally not transparent, is fit over an outside surface of the decoration zone 326 of the external connecting piece 32. The insert bore 314, the receptacle bore 313, and the water hole 321 are made in communication with each other to collectively define a water flow channel 36.

The light-emitting device 40 comprises a housing 41, an electrical generator 42, a blade wheel 43, a water guide 44, a sphere 45, a circuit board 46, a plurality of light-emitting diodes (LEDs) 47, a seal body 48, and a gasket ring 49. The housing 41 is disposed in the receptacle bore 313 of the connector seat 30. The housing 41 has an end that is wide open and an opposite end that is partly closed and is formed with a through hole 411. The electrical generator 42 is arranged in the housing 41. The electrical generator 42 has a rotary shaft 421 that extends through and projects outside the through hole 411. The blade wheel 43 is provided outside the end of the housing 41 that is formed with the through hole 411. The blade wheel 43 has a center that is coupled to the rotary shaft 421 of the electrical generator 42. The water guide 44 is coupled to the end of the housing 41 that is formed with the through hole 411 so as to have the blade wheel 43 located inside the water guide 44. The water guide 44 comprises a plurality of water passage openings 441 formed therein and in communication with an end face and a side surface thereof and the blade wheel 43 is arranged on a passageway defined by the water passage openings 441. The sphere 45 is positioned between and abutting an end face of the rotary shaft 421 of the electrical generator 42 and the water guide 44 to maintain smoothness of rotation of the rotary shaft. The circuit board 46 is disposed in the housing 41 and is electrically connected with the electrical generator 42. The LEDs 47 are electrically connected with and mounted on the circuit board 46. The seal body 48, which is transparent, is arranged on and close the open end of the housing 41 to seal the circuit board 46 and the electrical generator 42. The gasket ring 49 is positioned between and abutting the water guide 44 and the receptacle section 311 of the connector seat 30.

The fastening collar 50 is fit outside a connection site between the hose 10 and the connector seat 30 to prevent the connector seat 30 from detaching from the hose 10.

Referring to FIGS. 1-4, the second connector 60 is coupled to an opposite end of the hose 10.

The above provides a description to components of the light-emitting hose assembly 100 according to the preferred embodiment of the present invention and assembling thereof. The following will provide an operation of the light-emitting hose assembly.

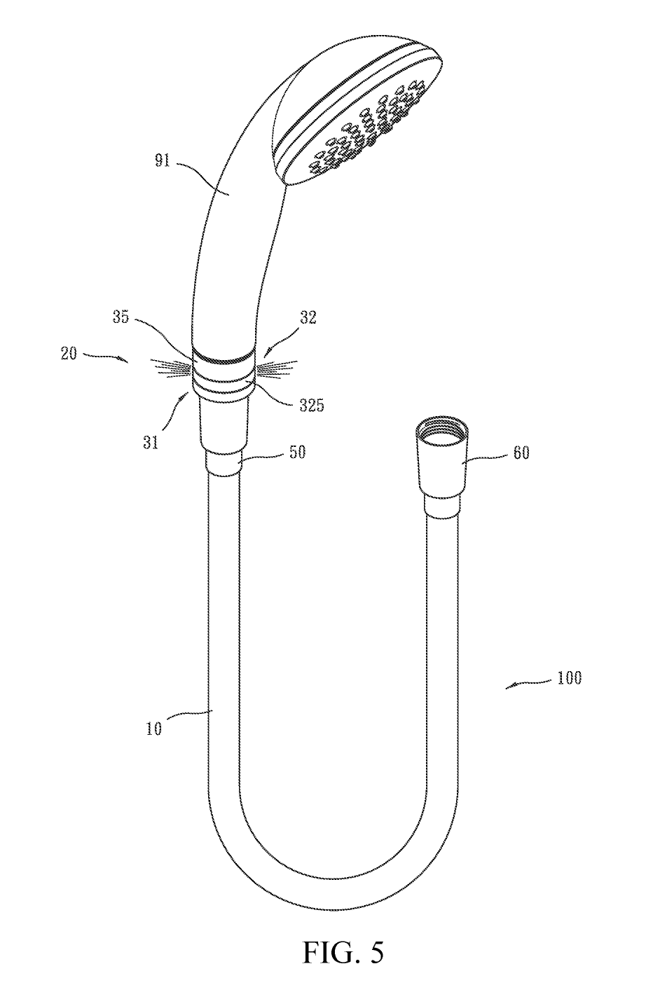

Firstly, as shown in FIG. 5, to use the present invention, the first connector 20 is connected to a shower head 91 and the second connector 60 is connected to a faucet or a water supply device.

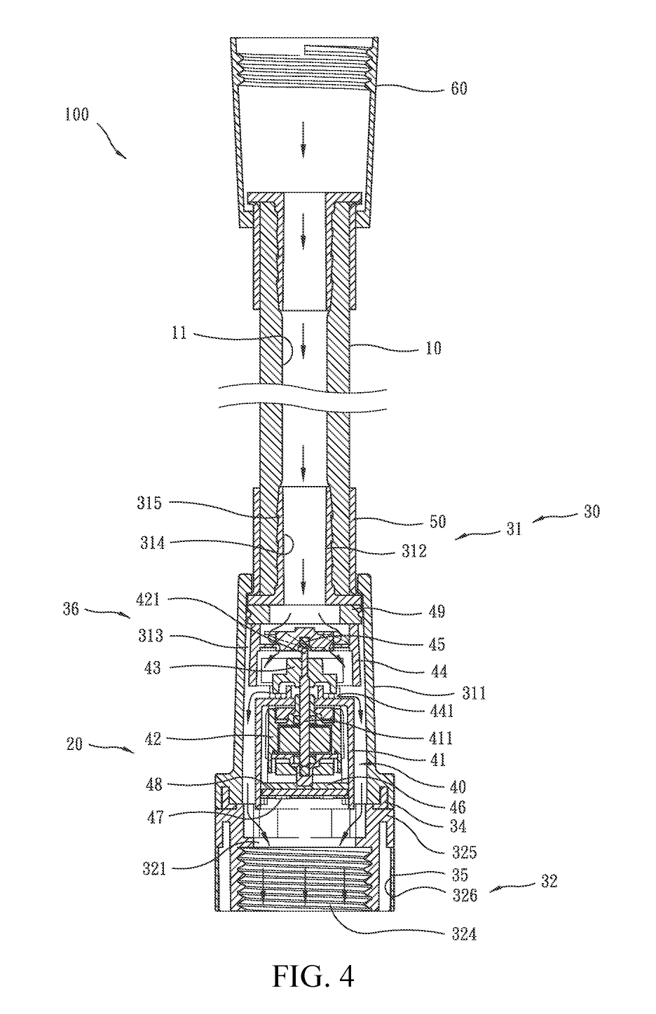

Next, as shown in FIG. 4, when the faucet is opened to allow water to flow therethrough and discharged therefrom, water first flows into the water passage 11 of the hose 10, and then flows through the insert bore 314 and the receptacle bore 313 of the first connector 10 and is guided into the water passage openings 441 of the water guide 44, so that water flows outward through the water passage openings 441 into the water hole 321 to be finally eject from the shower head 91.

When water flows through the water passage openings 441, the blade wheel 43 that is located in the water guide 44 is driven by the water flow to rotate and thus drive the rotary shaft 421 of the electrical generator 42 to rotate in synchronization therewith to cause the electrical generator 42 to generate electricity that is transmitted to the circuit board 46 and the LEDs 47 are energized by being supplied with such electricity to emit light. The light transmits out through the light transmitting zone 325 of the connector seat 30 (as shown in FIG. 5).

Thus, with the structural arrangement of the light-emitting hose assembly 100 provided according to the present invention, a user may enjoy a romantic atmosphere provided by the light so transmitted while taking a shower. In addition, the operation of the present invention requires no external power supply and is capable of emitting light even during power failure to provide lighting to the user who is taking a shower in the blackout.

Further, generally speaking, the hose is less frequently replaced than the shower head and due to such a less frequency of replacement, the cost that the user has to spend can be reduced.

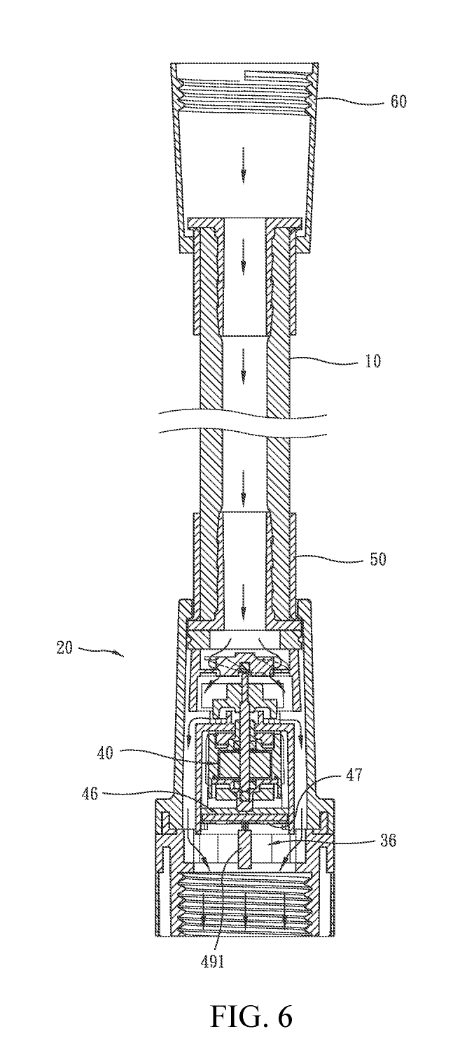

Next, as shown in FIG. 6, in the present invention, the light-emitting device 40 may further comprise at least one temperature sensor bar 491 or other types of temperature sensor. The temperature sensor bar 491 is arranged in the water hole 321 of the water flow channel 36 of the connector seat 30 and is electrically connected with the circuit board 46 to detect and transmit a temperature of the water flow to the circuit board 46. Thus, the circuit board 46 may be operated to control the LEDs 47 to generate light of different colors according to different temperature or different temperature ranges of the water flow. For example, when the temperature of the water flow is below 35° C., the LEDs 47 are controlled to emit blue light; when the temperature of the water flow is in the range of 35-45° C., the LEDs 47 are controlled to emit orange light; when the temperature of the water flow is above 45°, the LEDs 47 are controlled to emit red light, and as such, an effect of alarming may be achieved.

Further, although, in the above embodiments, the first connector is provided for connection with a shower head, in a different application, the first connector may be connected to a shower pillar or an elevating bar, if desired, to serve the same purposes.

Further, although, in the above embodiments, the second connector and the first connector are made of different structural arrangements, in a different application, the second connector can be made with a structure that is the same as the first connector so that both provide an effect of light emitting.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A light-emitting hose assembly, comprising:
a hose, which is formed with a water passage extending therethrough;
a first connector, which comprises a connector seat and a light-emitting device, the connector seat having an end connected to an end of the hose, the connector seat having an opposite end that is formed with an internal thread, the connector seat comprising a water flow channel extending therethrough, the water flow channel being in communication with the water passage of the hose, the light-emitting device being arranged in the water flow channel of the connector seat to receive water to flow therethrough to generate electricity and emit light that transmits out of the connector seat; and
a second connector, which is coupled to an opposite end of the hose.

2. The light-emitting hose assembly according to claim 1, wherein the first connector further comprises a fastening collar, the fastening collar being tightly fit over a connection site between the hose and the first connector.

3. The light-emitting hose assembly according to claim 1, wherein the connector seat comprises a hose connecting piece, an external connecting piece, and a plurality of pins, the hose connecting piece comprising a receptacle section and an insert section coupled to an end of the receptacle section, the receptacle section having a free end in which a receptacle bore is formed to extend inwardly therefrom, the insert section having a free end in which an insert bore is formed and extends inwardly, the insert bore being arranged in communication with the receptacle bore, the insert section having an outer circumferential surface that comprises a plurality of tapering ring sections, the insert section being inserted into the water passage at one end of the hose to couple to the hose, the free end of the receptacle section having an end face that is formed with a plurality of first positioning holes spaced from each other by a predetermined distance, the receptacle bore of the receptacle section having an internal circumferential surface that is formed with a plurality of coupling grooves, the external connecting piece comprising a water hole extending axially therethrough, the external connecting piece having an end having an end face that is formed with a plurality of second positioning holes spaced from each other by a predetermined distance, the external connecting piece being provided, on a part of an internal circumferential surface of the water hole that is adjacent to the second positioning holes, with a plurality of coupling blocks that project outward, the internal thread being formed on the internal circumferential surface of the water hole and adjacent to an opposite end thereof, the external connecting piece having an external circumferential surface that is formed with a light transmitting zone that is transparent, the light-emitting device emitting light that transmits out through the light transmitting zone, the coupling blocks of the external connecting piece being receivable into and combinable with the coupling grooves of the hose connecting piece, the bolts being received through the second positioning holes of the external connecting piece to screw into the first positioning holes of the hose connecting piece, respectively, in order to securely fix the hose connecting piece and the external connecting piece to each other, the water flow channel being formed of the insert bore, the receptacle bore, and the water hole that are in communication with each other.

4. The light-emitting hose assembly according to claim 3, wherein the connector seat further comprises a gasket, which is positioned between and abutting end faces of the hose connecting piece and the external connecting piece that coupled to each other.

5. The light-emitting hose assembly according to claim 3, wherein the connector seat further comprises a decoration ring, the external circumferential surface of the external connecting piece being formed with a decoration zone adjacent to the light transmitting zone, the decoration ring being fit over the decoration zone.

6. The light-emitting hose assembly according to claim 1, wherein the light-emitting device comprises a housing, an electrical generator, a blade wheel, a water guide, a circuit board, at least one light-emitting diode (LED), and a seal body, the housing being disposed in the water flow channel of the connector seat, the housing having an end that is open and an opposite end that is partly closed and is formed with a through hole, the electrical generator being arranged in the housing, the electrical generator having a rotary shaft that extends through and projects outside the through hole, the blade wheel being provided outside the end of the housing that is formed with the through hole, the blade wheel having a center that is coupled to the rotary shaft of the electrical generator, the water guide being coupled to the end of the housing that is formed with the through hole so as to have the blade wheel located inside the water guide, the water guide comprising a plurality of water passage openings in communication with an end face and a side surface thereof, the blade wheel being arranged in a passageway defined by the water passage openings, the circuit board being disposed in the housing and electrically connected with the electrical generator, the LED being electrically connected to the circuit board, the seal body being transparent and positioned in and sealing the open end of the housing to seal the circuit board and the electrical generator inside the housing.

7. The light-emitting hose assembly according to claim 6, wherein the light-emitting device further comprises a sphere, the sphere being positioned between and abutting an end face of the rotary shaft of the electrical generator and the water guide.

8. The light-emitting hose assembly according to claim 6, wherein the light-emitting device further comprises a gasket ring, the gasket ring being positioned between and abutting the water guide and the connector seat.

9. The light-emitting hose assembly according to claim 6, wherein the light-emitting device further comprises at least one temperature sensor bar, the temperature sensor bar being arranged in the water flow channel of the connector seat and electrically connected with the circuit board to detect and transmit a temperature of a water flow to the circuit board so that the circuit board is operable to control the LED to emit light of different colors in response to different temperatures of the water flow.

10. The light-emitting hose assembly according to claim 1, wherein the second connector has a structure identical to a structure of the first connector.
